(19) United States
(12) Patent Application Publication
(10) Pub. No.: US 2026/0273749 A1
(43) Pub. Date: Sep. 17, 2026

(54) CONTROL DEVICE, CONTROL SYSTEM, CONTROL METHOD, AND STORAGE MEDIUM

(71) Applicant: HONDA MOTOR CO., LTD., Tokyo (JP)

(72) Inventor: Shun Ogiwara, Wako-shi (JP)

(21) Appl. No.: 19/336,534

(22) Filed: Sep. 23, 2025

(30) Foreign Application Priority Data
Oct. 9, 2024 (JP) 2024-177006

(51) Int. Cl. B25J 9/16; B25J 13/08

(52) U.S. Cl. CPC B25J 9/1674; B25J 13/088

(57) ABSTRACT

A control device includes an attachment portion where a sensor is attached to a main body controlled by a control device, an acquisition unit configured to acquire position information of a position to which the attachment portion is attached and sensor identification information of the sensor attached to the attachment portion, an extraction unit configured to extract sensor specification information based on the sensor identification information from a sensor specification database that stores specification information of the sensor, and a reflection unit configured to reflect the sensor specification information and the position information of the position to which the sensor is attached to a control parameter.

### CROSS-REFERENCE TO RELATED APPLICATION

Priority is claimed on Japanese Patent Application No. 2024-177006, filed Oct. 9, 2024, the content of which is incorporated herein by reference.

### BACKGROUND OF THE INVENTION

### Field of the Invention

The present invention relates to a control device, a control system, a control method, and a storage medium.

### Description of Related Art

For example, a robot is equipped with many sensors. A control device of the robot acquires data from these many sensors and controls an operation of the robot. For example, a device that acquires information from many sensors and provides services has been proposed (refer to Patent Document 1 below).

A plurality of these sensors may be replaced, for example, during repairs. When replacing with a sensor made by a different manufacturer from a sensor originally attached, characteristics of the sensor may differ from those of the sensor originally attached. When the sensors are different, physical information of the sensors is also different. The physical information of the sensors is, for example, shapes of the sensors, weights of the sensors, detection coordinates of the sensors, or the like.

### PATENT DOCUMENTS

[Patent Document 1] Japanese Unexamined Patent Application, First Publication No. 2017-11525

### SUMMARY OF THE INVENTION

However, in conventional technology, when replacing with a sensor made by a different manufacturer from the sensor originally attached, a designer or the like of the robot had to modify robot parameters corresponding to the physical information to match a specification of the replaced sensor.

Aspects of the present invention have been made in consideration of the problems described above, and aim to provide a control device, a control system, a control method, and a storage medium that are capable of performing control without the designer or the like of a main body of a control target to which a sensor is attached modifying control parameters when the sensor is attached.
(1): A control device according to one aspect of the present invention includes an attachment portion where a sensor is attached to a main body controlled by a control device, an acquisition unit configured to acquire position information of a position to which the attachment portion is attached and sensor identification information of the sensor attached to the attachment portion, an extraction unit configured to extract sensor specification information based on the sensor identification information from a sensor specification database that stores specification information of the sensor, and a reflection unit configured to reflect the sensor specification information and the position information of the position to which the sensor is attached to a control parameter.
(2): In the aspect of (1) described above, a sensor attachment connector may be installed in the main body, the sensor attachment connector may be assigned unique communication identification information, and the acquisition unit may acquire position information from a position of the sensor attachment connector linked to the unique communication identification information.
(3): In the aspect of (1) or (2) described above, specification information of the sensor may include geometric information of the sensor.
(4): In the aspect of any one of (1) to (3) described above, the reflection unit may reflect geometric information after the sensor is attached to the main body according to a position where the sensor is attached into geometric information before the sensor is attached to the main body.
(5): In the aspect of any one of (1) to (4) described above, the attachment portion may have a determined reference position in the main body, the sensor may have a determined reference position in the sensor, and a detection position of the sensor may be defined as a relative coordinate from the reference position of the sensor.
(6): A control system according to another aspect of the present invention includes a control device, a sensor attached to a main body controlled by the control device, and a database configured to store specification information including geometric information of the sensor, in which the control device includes an attachment portion where the sensor is attached to the main body, an acquisition unit configured to acquire position information of a position to which the attachment portion is attached and sensor identification information of the sensor attached to the attachment portion, an extraction unit configured to extract sensor specification information based on sensor identification information from a sensor specification database that stores specification information of the sensor, and a reflection unit configured to reflect the sensor specification information and the position information of the position to which the sensor is attached into control parameters.
(7): In the control system according to the aspect of (6) described above, the main body may be a robot including fingers, and the control device may include a control unit that uses a reflected control parameter and a detection value acquired from the sensor to control an operation of a part of the main body to which the sensor is attached.
(8): A control method according to still another aspect of the present invention is a control method that controls a control device including an attachment portion where a sensor is attached to a main body controlled by the control device, and includes acquiring, by an acquisition unit, position information of a position to which the attachment portion is attached and sensor identification information of the sensor attached to the attachment portion, extracting, by an extraction unit, sensor specification information based on sensor identification information from a sensor specification database that stores specification information of the sensor, and reflecting, by a reflection unit, the sensor specification information and the position information of the position to which the sensor is attached into control parameters.
(9): A computer-readable non-transitory storage medium according to still another aspect of the present invention has stored a program causing a computer of a control device including an attachment portion where a sensor is attached to a main body controlled by the control device to execute acquiring position information of a position to which the attachment portion is attached and sensor identification information of the sensor attached to the attachment portion, extracting sensor specification information based on sensor identification information from a sensor specification database that stores specification information of the sensor, and reflecting the sensor specification information and the position information of the position to which the sensor is attached into control parameters.

According to the aspect of the present invention, when a sensor is attached, the designer of the main body of the controlled object to which the sensor is attached can control the sensor without modifying the control parameters.

### BRIEF DESCRIPTION OF THE DRAWINGS

FIG. 1 is a diagram which shows an example of a schematic configuration of a control system according to an embodiment.

FIG. 2 is a diagram which shows an example of a configuration of the control system according to the embodiment.

FIG. 3 is a diagram which shows an example of information stored in a database according to the embodiment.

FIG. 4 is a diagram which shows an example of a connection between a robot and a sensor unit according to the embodiment.

FIG. 5 is a diagram which shows an example of a memory area for specification information on a sensor unit stored by a storage unit.

FIG. 6 is a flowchart of processing performed by a control device according to the embodiment.

FIG. 7 is a flowchart of processing for operation control according to the embodiment.

FIG. 8 is a diagram which shows an example of the configuration of the control system when a communication bus is CAN.

### DETAILED DESCRIPTION OF THE INVENTION

Hereinafter, an embodiment of the present invention will be described with reference to the drawings. In the drawings used in the following description, a scale of each member has been appropriately changed so that each member can be recognized.

In all the drawings used to describe the embodiment, the same reference symbol is used for members having the same function, and repeated descriptions will be omitted.

“On the basis of XX” in this application means “based on at least XX” and includes cases of being based on other elements in addition to XX. “On the basis of XX” is not limited to cases where XX is directly used, and also includes cases where calculation or processing is performed on XX. “XX” is any element (for example, any information).

### System Outline

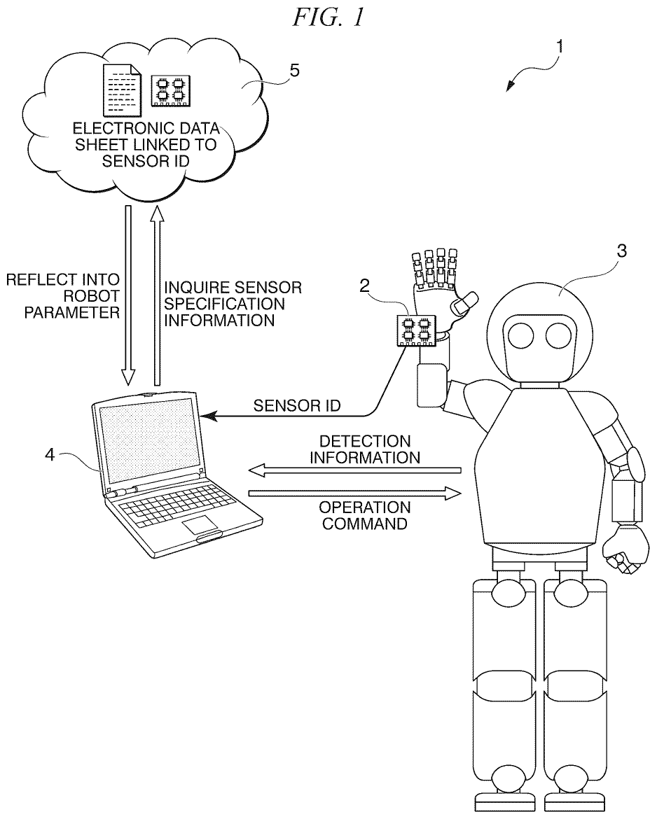

FIG. 1 is a diagram which shows an example of a schematic configuration of a control system of the present embodiment. As shown in FIG. 1, a control system 1 includes, for example, a sensor unit 2 (sensor), a robot 3, a control device 4, and a database 5. The control device 4 may be included in the robot 3.

The robot 3 is, for example, a bipedal robot equipped with a multi-fingered hand.

The sensor unit 2 is attached, for example, to a shoulder, an elbow, a wrist, fingers, and the like of the robot 3.

The control device 4 acquires sensor identification information (sensor ID) of the attached sensor unit 2. The control device 4 acquires communication identification information (communication ID) on a bus to which the sensor unit 2 of the acquired identification information is attached. The control device 4 uses the acquired sensor identification information to inquire of the database 5 about specification information of the attached sensor unit 2 and acquires it. The control device 4 reflects the acquired specification information of the sensor unit 2 in parameters for controlling the robot 3. The control device 4 acquires detection information detected by the sensor from the sensor unit 2. The control device 4 generates an operation command for the robot 3 on the basis of the reflected parameters and the acquired detection information, and outputs the generated operation command to the robot 3.

The database 5 stores specification information of a plurality of sensor units 2. The database 5 links the specification information to identification information of the sensor units 2 and stores it.

### Configuration Example of System

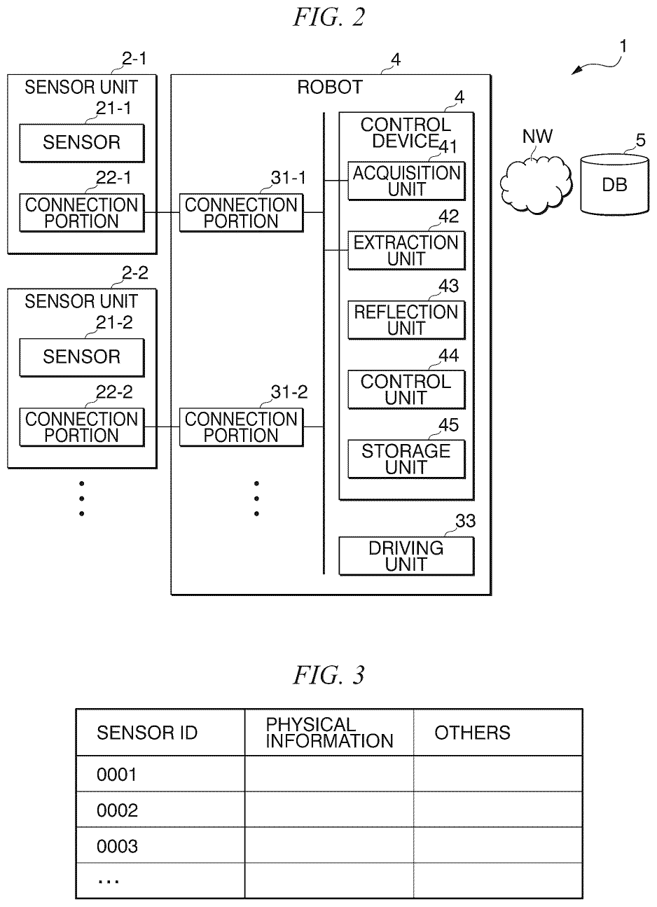

FIG. 2 is a diagram which shows a configuration example of the control system of the present embodiment.

The sensor unit 2 (2-1, 2-2, . . . ) includes a sensor 21 (21-1, 21-2, . . . ) and a connection portion 22 (22-2, 22-3, . . . ).

The robot 3 includes, for example, a connection portion 31 (31-1, 31-2, . . . ) (attachment portion), a communication bus 32, a driving unit 33, and a control device 4.

The control device 4 includes, for example, an acquisition unit 41, an extraction unit 42, a reflection unit 43, a control unit 44, and a storage unit 45.

The robot 3 and the database 5 are connected via a wired or wireless network.

The connection portion 22 of the sensor unit 2 is connected to the connection portion 31 of the robot 3.

The connection portion 31 is connected to the control device 4 via the communication bus 32.

The sensor 21 is, for example, a force sensor, a pressure sensor, an acceleration sensor, a six-axis sensor, or the like.

The connection portion 22 is, for example, a connector, a connection terminal, or the like.

### Robot

The connection portion 31 is, for example, a connector, or the like. The connection portion 31 includes, for example, a screw hole or the like used to fix the sensor unit 2 to the robot 3.

The communication bus 32 is, for example, a communication line that runs through each part inside the robot 3 to which the sensor unit 2 is attached.

The driving unit 33 drives each driving unit of the robot 3 according to control of the control device 4.

When the sensor unit 2 is attached to the connection portion 31, the acquisition unit 41 acquires a sensor ID, which is the identification information of the sensor unit 2, and a communication ID, which is the identification information of the connection portion 31 to which the sensor unit 2 is attached. After the sensor unit 2 is attached, the acquisition unit 41 detects to which reference position of the robot 3 the sensor unit 2 is attached on the basis of the communication ID.

The extraction unit 42 inquires of the database 5 via the network NW about the specification information linked to the acquired sensor ID and extracts it. A file format extracted from the database 5 is, for example, yet another markup language (YAML) file format, but the file format is not limited to this.

The reflection unit 43 reflects the extracted specification information of the sensor unit 2, and the like in robot parameters (control parameters) used to control the robot 3. For example, the reflection unit 43 reflects mechanism information (shape, weight, and the like) included in the specification information of the sensor unit 2 in mechanism information of the robot 3 before the sensor unit 2 is attached.

The control unit 44 controls an operation of the robot 3 on the basis of the robot parameters reflected by the reflection unit 43. The control unit 44 uses the communication ID and the acquired specification information to link sensor attachment position information and sensor information, and stores them in the storage unit 45. The control unit 44 treats the sensor data acquired from each sensor unit 2 as robot sensor data on the basis of, for example, a reference position of the robot 3 to which the sensor unit 2 is attached, a shape and a weight of the sensor unit 2, a detection position of the sensor 21 in a robot coordinate system, a type and the number of channels of the sensor, detection sensitivity per data format, data size, element, and the like.

The storage unit 45 stores a program, a threshold value, a formula, an algorithm, and the like used by the control unit 44 for control. It stores the reference position to which the sensor unit 2, which will be described below, is attached. The storage unit 45 stores mechanism information (shape, weight, and the like) of the robot 3 before the sensor unit 2 is attached.

### Information Stored in Database

FIG. 3 is a diagram which shows an information example stored in a database of the present embodiment.

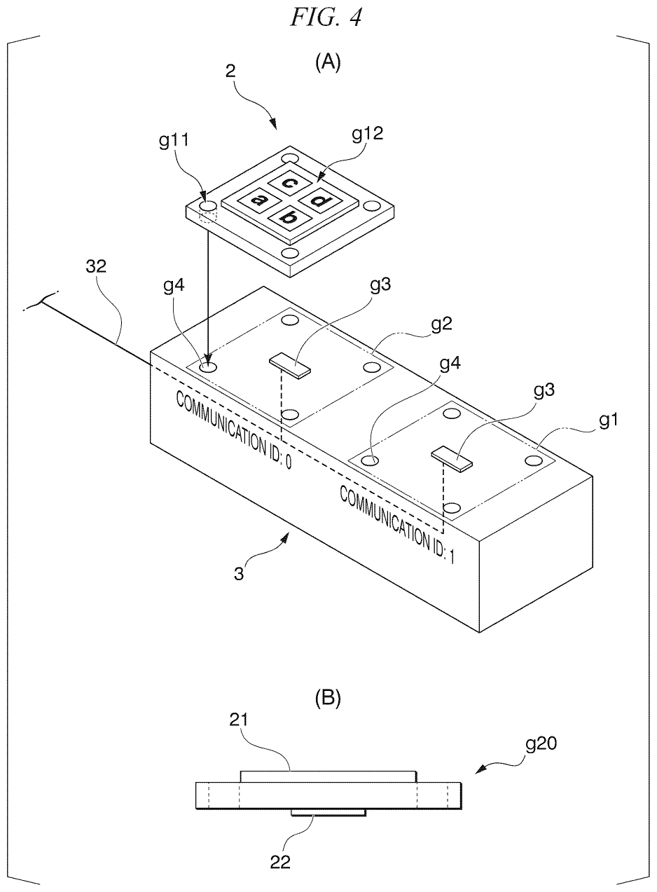

The database 5 links physical information and other information to the sensor ID for each sensor unit 2 and stores it. The physical information is, for example, the shape of a sensor, the weight of a sensor, and coordinates of a detection point detected by a sensor (for example, positions a, b, c, and d in FIG. 4). The other information is, for example, the type information of a sensor, the number of channels of a sensor, data format of detection information of a sensor (for example, an arrangement of data), a data size of the detection information of the sensor, a detection value per element, and the like. The detection value per element is, for example, how many Nm 1 LSB is when the sensor unit 2 is a pressure sensor. The detection value per element is stored in the database 5 as a relative coordinate from the reference position of the sensor unit 2, which is the detection position of the sensor 21 of the sensor unit 2.

### Sensor Unit

Here, the sensor unit 2 of the present embodiment will be further described.

The sensor unit 2 is created by, for example, a designer of the robot 3, specifying the physical attachment position. For example, when the sensor unit 2 attached to the finger is to detect touch with the finger, a sensor unit 2 equipped with a touch sensor is created. The designer then assigns a sensor ID to this sensor unit 2, and registers the sensor ID and the specification information of the sensor and sensor unit 2 in the database. When the sensor unit 2 created in this manner is created and sold by, for example, a third party, the sensor ID is assigned to this sensor unit 2, and the specification information on this sensor is registered in the database 5. The specification information on the sensor unit 2 of the third party may be registered in the database 5 by the designer or by the third party.

### Connection Example of Sensor Unit

FIG. 4 is a diagram which shows an example of connection between a robot and a sensor unit of the present embodiment.

A reference symbol g1 is an installation range of the sensor unit 2. A reference symbol g2 is an installation range of the sensor unit 2.

A reference symbol g3 is the connection portion 31 with the sensor unit 2.

A reference symbol g4 is a reference position on the robot 3 side too which the sensor unit 2 is attached. The reference position on the robot 3 side is, for example, one of a plurality of screw positions for attachment. This reference position on the robot 3 side is a known position and is stored in the storage unit 45.

A reference symbol g11 is a reference position on the sensor unit 2 side and is, for example, one of the plurality of screw positions for attachment.

The sensor unit 2 has, for example, four sensors 21 on its surface as shown in FIG. 4. Reference symbols a, b, c, and d of each sensor 21 show examples of the detection points of the sensors. The sensor unit 2 has a connection portion 22 on the back side. A reference symbol g20 is a diagram of the sensor unit 2 when viewed from the side.

A reference symbol g12 is the detection position, and is defined as a relative coordinate from the reference position on the sensor side. This detection position is stored in the database 5 as one piece of the specification information. For example, an order of reference symbols a, b, c, and d is also stored in the database 5.

The sensor unit 2 is attached so that a screw hole (attachment hole) that is the reference position on the sensor unit 2 matches a screw hole that is the reference position on the robot 3. In this manner, it is preferable that screw holes of the sensor unit are not symmetrical, for example, left and right or up and down, so that the attachment is unique. Alternatively, a pin for determining a direction may be provided on the sensor unit 2 side, and a hole into which the pin fits may be provided on the robot 3 side.

In the example shown in FIG. 4, although the connection portion 22 and the connection portion 31 have been described as examples of connectors, a connection method is not limited to this. For example, the connection portion 31 on the robot 3 side may be a memory socket (memory connector) used in personal computers, and the like. In this case, the connection portion 22 on the sensor unit 2 side may have a terminal directly mounted on a board.

### Coordinate System

The reference position of the robot 3 is known, for example, in the robot coordinate system. As described above, the sensor unit 2 is attached so that the screw hole (attachment hole) that is the reference position matches the screw hole that is the reference position of the robot 3, so that the reference position of the sensor unit 2 matches the reference position of the robot 3. For this reason, a sensor detection value can be converted from a sensor coordinate system into the robot coordinate system. As mentioned above, the detection position is defined as a relative coordinate from the reference position, so that the sensor detection value is expressed in the robot coordinate system.

### Example of Memory Area Stored by Storage Unit

FIG. 5 is a diagram which shows an example of a memory area for specification information on a sensor unit stored by a storage unit.

An area in the storage unit 45 that stores information on the sensor unit 2 is, for example, 48 bytes for each sensor unit 2. 48 bytes is an example and the present invention is not limited to this. For example, when the sensor unit 2 in FIG. 4 is attached to an attachment position with a communication ID of 0, the storage unit 45 stores data of a detection point “point a” in a 0^{th} byte, data of a detection point “point b” in a 1^{st} byte, data of a detection point “point c” in a 2^{nd} byte, and data of a detection point “point d” in a 3^{rd} byte, and sets 4^{th} to 47^{th} bytes as invalid data. The number of bytes of such valid data is included in a data size of the specification information stored in the database 5. A data size and the like of each sensor unit 2 are stored for each attached sensor unit 2 in a separate area of the storage unit 45.

### Processing Procedure at Startup

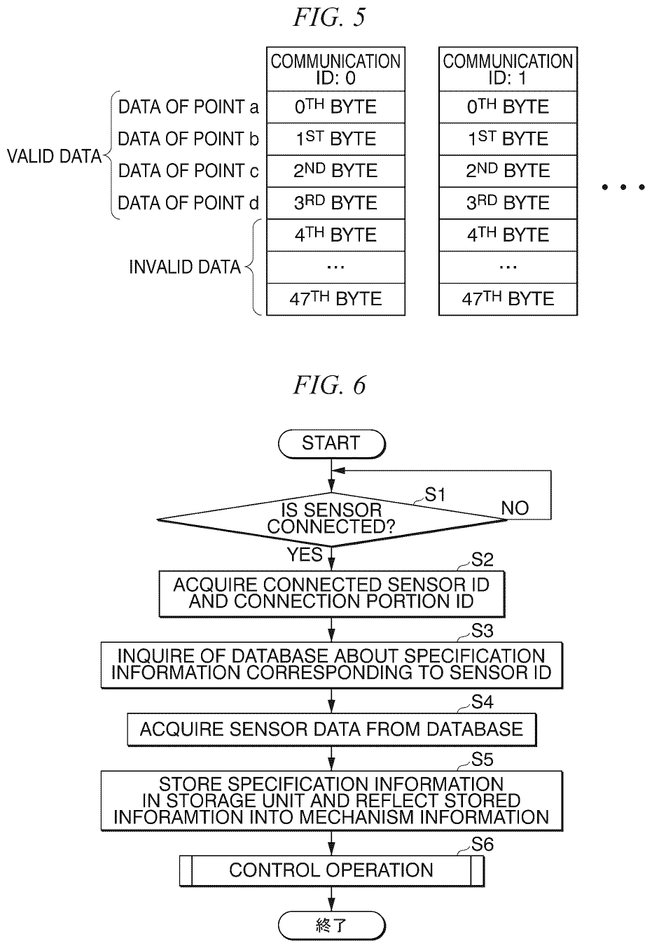

FIG. 6 is a flowchart of the processing performed by a control device of the present embodiment. A processing procedure example in FIG. 6 is an example performed when the robot 3 is started up.
(Step S1) The acquisition unit 41 determines whether the sensor unit 2 is connected to any of the connection portion 31. When the sensor unit 2 is connected to any of the connection portion 31 (YES in Step S1), the acquisition unit 41 proceeds to processing of Step S2. When the sensor unit 2 is not connected to any of the connection portion 31 (NO in Step S1), the acquisition unit 41 repeats processing of Step S1.
(Step S2) The acquisition unit 41 acquires a sensor ID, which is the identification information of the sensor unit 2, and a communication ID, which is the identification information of the connection portion 31 to which the sensor unit 2 is attached. The acquisition unit 41 detects to which reference position of the robot 3 the sensor unit 2 is attached on the basis of the communication ID.
(Step S3) The extraction unit 42 inquires of the database 5 via the network NW about the specification information linked to the acquired sensor ID.
(Step S4) The extraction unit 42 extracts and acquires the specification information linked to the acquired sensor ID. The extraction unit 42 writes the acquired specification information into a storage area in the storage unit 45 for storage, for example, for each communication ID.
(Step S5) The reflection unit 43 reflects the mechanism information (shape, weight, and the like) included in the specification information of the sensor unit 2 in the mechanism information of the robot 3 before the sensor unit 2 is attached.
(Step S6) The control unit 44 uses the communication ID and the acquired specification information to link the sensor attachment position information to the sensor information and stores it in the storage unit 45. Next, the control unit 44 controls the operation of the robot 3 on the basis of robot parameters that reflect the specification information of the sensor unit 2. The control unit 44 ascertains which memory area stores information of which sensor (detection position, data size, detection sensitivity, or the like) according to information on the startup processing as shown in FIG. 5, and therefore, handles the sensor data based on this linking.

The control method, procedures, and the like described using FIG. 6 are merely examples and are not limited to these. For example, the processing of steps S2 and S3 may be performed simultaneously. When step S1 is NO, the operation of the robot 3 may be controlled without performing the processing of steps S2 to S5.

In the example described above, an example in which connection confirmation processing of the sensor unit 2 is performed at startup is described, but when the sensor unit 2 is one that can be added or replaced while power is on, connection confirmation may be performed during startup.

The sensor ID, communication ID, and specification information of the sensor unit 2 confirmed at startup may be stored in the storage unit 45 and compared with the acquired information for confirmation. When the sensor ID and communication ID of the sensor unit 2 confirmed at startup have not changed since a previous startup, the specification information stored in the storage unit 45 may be used without being acquired from the database 5.

### Example of Operation Control

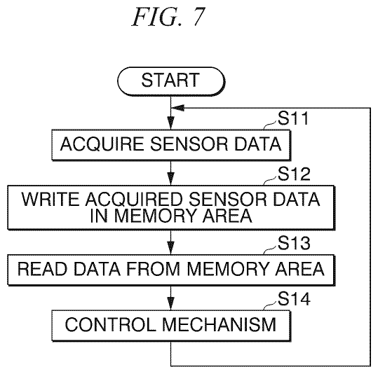

Next, processing performed by the control unit 44 in step S6 in FIG. 6 will be described. FIG. 7 is a flowchart of processing for operation control in the present embodiment. The control unit 44 performs the following processing for each sensor ID.
(Step S11) The control unit 44 acquires sensor data from the sensor unit 2, for example, at predetermined intervals according to information based on the sensor ID.
(Step S12) The control unit 44 writes the acquired sensor data into a memory area corresponding to a communication ID for storage.
(Step S13) The control unit 44 acquires data from the memory area in which the sensor data is stored.
(Step S14) The control unit 44 reflects the sensor information (shape, weight, and the like) based on the sensor ID and performs mechanism control of, for example, the fingers and the like.

Hereinafter, the control unit 44 repeats the processing of steps S11 to S14.

### Example of CAN Communication Bus

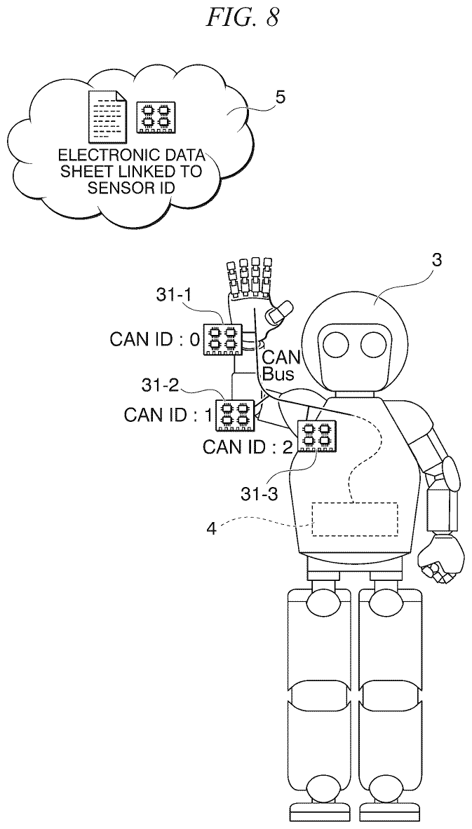

FIG. 8 is a diagram which shows an example of the configuration of the control system when the communication bus is CAN.

In this example, by defining a controller area network (CAN) ID corresponding to the attachment position of each sensor unit 2 instead of the communication ID, it becomes possible to identify the sensor attachment position from the ID information included in the acquisition data.

In FIG. 8, CAN is described as an example of the communication bus 32, but the communication bus 32 may be of another standard.

As described above, in the present embodiment, the sensor ID of the sensor unit 2 is linked to the specification information of the sensor unit 2 and stored in the database 5. In the present embodiment, when the sensor unit 2 is attached, the sensor ID of the sensor unit 2 and the attached communication ID are acquired. In the present embodiment, the specification information of the acquired sensor ID is extracted from the database 5, and the extracted specification information and the like are reflected in the robot parameters to control the operation of the robot 3.

As a result, according to the present embodiment, when a third party develops the sensor unit 2, an external interface (IF) specification (for example, ID, data format, sensor unit size, reference position, and the like) can be specified, so that even when a user of the system has attached the sensor of the third-party, the designer does not need to handle reflection of the robot parameters. In other words, for example, even if an external user of the robot 3 other than the designer installs the sensor unit 2 of the third-party, the designer does not need to reflect the robot parameters for control each time. Then, the external user can obtain an advantage of being able to use even the sensor unit 2 of the third-party when he or she wants to change sensitivity of the sensor depending on an application or when replacing the sensor at a time of a malfunction.

According to the present embodiment, it is possible to grasp to which on the robot 3 (a position on the robot) the sensor unit 2 is attached. According to the present embodiment, since the sensor attachment position information and the sensor information are linked, the control unit 44 can recognize from which sensor unit 2 the data is acquired. In the present embodiment, a different sensor ID is assigned to each sensor unit 2, and a different communication ID (CAN-ID in a case of CAN) is defined for each attachment portion (connection portion 31) on the robot 3 side, so that the sensor attachment position can be specified. In the present embodiment, each piece of sensor data can reflect sensor detection coordinate information, which indicates which coordinates of the robot 3 a sensor detection point is located at, to the robot system. In the present embodiment, the detection point coordinates specify a mechanical attachment origin (reference point) and are defined as relative coordinates from it, so that the control unit 44 can recognize the sensor detection coordinate information.

In the example described above, an example in which the sensor unit 2 is attached to the finger of the robot 3 has been described, but the present invention is not limited thereto. For example, the sensor unit 2 may be attached to a location, moving part, or device whose control is affected before and after the sensor unit 2 is attached, or a location to which the sensor unit 2 is attached may be a location, moving part, or device that is operated under control.

A program for realizing all or part of functions of the control device 4 in the present invention may be recorded on a computer-readable recording medium, and the program recorded on this recording medium may be read into a computer system and executed to perform all or part of processing performed by the control device 4. A term “computer system” here includes an OS and hardware such as peripheral devices. It is assumed that the term “computer system” also includes a WWW system equipped with a homepage providing environment (or display environment). A term “computer-readable recording medium” refers to a portable medium such as a flexible disk, an optical magnetic disc, an ROM, or a CD-ROM, or a storage device such as a hard disk embedded into the computer system. Furthermore, the “computer-readable recording medium” includes a storage medium that holds a program for a certain period of time, such as volatile memory (RAM) inside a computer system that serves as a server or client when the program is transmitted via a network such as the Internet or a communication line such as a telephone line.

Alternatively, some or all of these components may be realized by hardware (circuit unit; including circuitry) such as large scale integration (LSI), an application specific integrated circuit (ASIC), a field-programmable gate array (FPGA), a graphics processing unit (GPU), or a system on chip (SOC), or may be realized by software and hardware in cooperation.

The program described above may be transmitted from a computer system that stores the program in a storage device, or the like, to another computer system via a transmission medium, or by transmission waves in the transmission medium. Here, the “transmission medium” that transmits the program refers to a medium that has a function of transmitting information, such as a network (communication network) such as the Internet or a communication line (communication line) such as a telephone line. The program described above may be a program for realizing part of the functions described above. Furthermore, it may be a so-called differential file (differential program) that can realize the functions described above in combination with a program already recorded in a computer system.

As described above, a form for carrying out the present invention has been described using the embodiment, but the present invention is not limited to such an embodiment, and various modifications and substitutions can be made within a range that does not deviate from the gist of the present invention.

What is claimed is:

1. A control device comprising:
an attachment portion where a sensor is attached to a main body controlled by a control device;
an acquisition unit configured to acquire position information of a position to which the attachment portion is attached and sensor identification information of the sensor attached to the attachment portion;
an extraction unit configured to extract sensor specification information based on the sensor identification information from a sensor specification database that stores specification information of the sensor; and
a reflection unit configured to reflect the sensor specification information and the position information of the position to which the sensor is attached into control parameters.

2. The control device according to claim 1,
wherein a sensor attachment connector is installed in the main body,
the sensor attachment connector is assigned unique communication identification information, and
the acquisition unit acquires position information from a position of the sensor attachment connector linked to the unique communication identification information.

3. The control device according to claim 1,
wherein specification information of the sensor includes geometric information of the sensor.

4. The control device according to claim 1,
wherein the reflection unit reflects geometric information after the sensor is attached to the main body according to a position where the sensor is attached in geometric information before the sensor is attached to the main body.

5. The control device according to claim 1,
wherein the attachment portion has a determined reference position in the main body,
the sensor has a determined reference position in the sensor, and
a detection position of the sensor is defined as a relative coordinate from the reference position of the sensor.

6. A control system comprising:
a control device;
a sensor attached to a main body controlled by the control device; and
a database configured to store specification information including geometric information of the sensor,
wherein the control device includes
an attachment portion where the sensor is attached to the main body,
an acquisition unit configured to acquire position information of a position to which the attachment portion is attached and sensor identification information of the sensor attached to the attachment portion,
an extraction unit configured to extract sensor specification information based on sensor identification information from a sensor specification database that stores specification information of the sensor, and
a reflection unit configured to reflect the sensor specification information and the position information of the position to which the sensor is attached into control parameters.

7. The control system according to claim 6,
wherein the main body is a robot including fingers, and
the control device includes a control unit that uses a reflected control parameter and a detection value acquired from the sensor to control an operation of a part of the main body to which the sensor is attached.

8. A control method that controls a control device including an attachment portion where a sensor is attached to a main body controlled by the control device, comprising:
acquiring, by an acquisition unit, position information of a position to which the attachment portion is attached and sensor identification information of the sensor attached to the attachment portion,
extracting, by an extraction unit, sensor specification information based on sensor identification information from a sensor specification database that stores specification information of the sensor, and
reflecting, by a reflection unit, the sensor specification information and the position information of the position to which the sensor is attached into control parameters.

9. A computer-readable non-transitory storage medium that has stored a program causing a computer of a control device including an attachment portion where a sensor is attached to a main body controlled by the control device to execute:
acquiring position information of a position to which the attachment portion is attached and sensor identification information of the sensor attached to the attachment portion,
extracting sensor specification information based on sensor identification information from a sensor specification database that stores specification information of the sensor, and
reflecting the sensor specification information and the position information of the position to which the sensor is attached into control parameters.
